(19) United States
(12) Patent Application Publication
(10) Pub. No.: US 2011/0062618 A1
(43) Pub. Date: Mar. 17, 2011

(54) Collapsible Nested Container

(76) Inventor: Timothy Raymond, West Chicago, IL (US)

(21) Appl. No.: 12/793,532

(22) Filed: Jun. 3, 2010

Related U.S. Application Data
(60) Provisional application No. 61/228,439, filed on Jul. 24, 2009.

(51) Int. Cl. B28B 17/00

(52) U.S. Cl. 264/109; 249/13

(57) ABSTRACT

A collapsible container comprising detachable nested sections. The nested sections are tapered and coaxially disposed. Nested sections can be disposed within the largest section in its collapsed position. In its expanded position, the lower portion of a section engages with the top portion of the section immediately below the upper section to mechanically lock the sections into its expanded formation, such that the container is self supporting. The sections are detachable, and when overturned and removed, can be used as a mold for creating parts of a sand castle. The removed sections can be joined in sequence to other removed section to vary the volume of sand being molded. The sides of each section comprise decorative molding shapes or patterns for creating parts of a sand castle. The bottom surface of the mold further comprises mold shapes for creating part of a sand castle when overturned.

### FIELD OF THE INVENTION

This invention relates to the field of amusement devices and containers.

### BACKGROUND OF THE INVENTION

Containers of various shapes are often used to make sandcastles. Containers can be used to transport sand to build a sand castle, and/or used to mold sand to form portions of a sand castle. Such containers are usually bulky, thus having several containers to provide for different sized molds is generally not feasible for storage purposes. Furthermore, such containers are of limited use because they are of constant volume.

The present inventor has recognized the need for a container for making sand castles that can be expanded and collapsed.

The present inventor has recognized the need for a container for making sand castles that incorporates mold designs.

The present inventor has recognized the need for a detachable container for making sand castles.

The present inventor has recognized the need for a container with adjustable volume.

The present inventor has recognized the need for a container that can be stored easily.

### SUMMARY OF THE INVENTION

A collapsible container comprising detachable sections. In one embodiment, the sections are tapered and coaxially disposed. Subsequent sections are proportionally smaller such that each section can be disposed or nested within a larger section when the container is in its collapsed position. In its expanded position, the lower portion of an upper section engages with the top portion of the section immediately below the upper section to mechanically lock the sections into its expanded formation, such that the container is self-supporting. The sections are detachable, and when overturned, can be used as a mold for creating parts of a sand castle. The detached sections can be joined in sequence with other detached sections to vary the volume of sand in the container. The sides of each section comprise decorative molding shapes or patterns for creating decorative patterns or designs on the side of a sand castle. The bottom section has a bottom surface which comprises mold shapes for creating part of a sand castle when overturned.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a perspective view of an exemplary embodiment of the container in its expanded form.

FIG. 2 is a perspective view of an exemplary embodiment of a top section of the container.

FIG. 2A is a front view of the top section of FIG. 2.

FIG. 3 is an exemplary embodiment of an intermediate section of the container.

FIG. 3A is an exemplary embodiment of an interlocking mechanism.

FIG. 4 is an exemplary embodiment of a bottom section of the container.

FIG. 5 is a view of the bottom section of the container of FIG. 4 in an upturned position.

FIG. 6 illustrates the container of FIG. 1 in its collapsed state.

FIG. 7 is a perspective view of an exemplary embodiment of the interlocking mechanism of the container.

FIGS. 8A and 8B illustrate another embodiment of the collapsible container.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

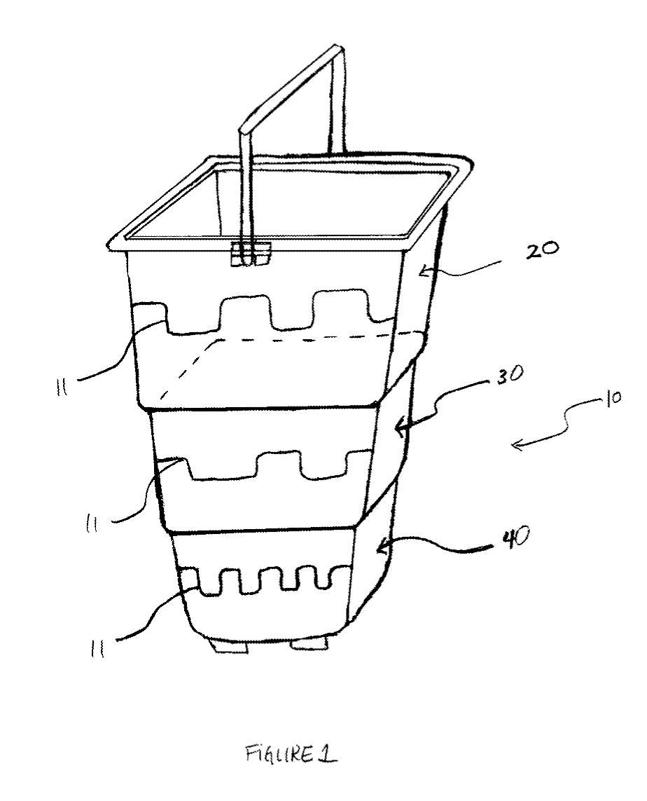

FIG. 1 illustrates an exemplary embodiment of the collapsible nested container 10. As illustrated, the container comprises three sections—a top section 20, an intermediate section 30, and a bottom section 40. Other embodiments may comprise more than one intermediate section between the top section 20 and bottom section 40. In an alternative embodiment, the nested container may contain a top section 20 and a bottom section without an intermediate section 30. A section below a higher section of the collapsible container 10 in its extended position is a subsequent section. A section above a lower section of the collapsible container 10 in its extended position is a preceding section. Intermediate sections are both a preceding section and a subsequent section.

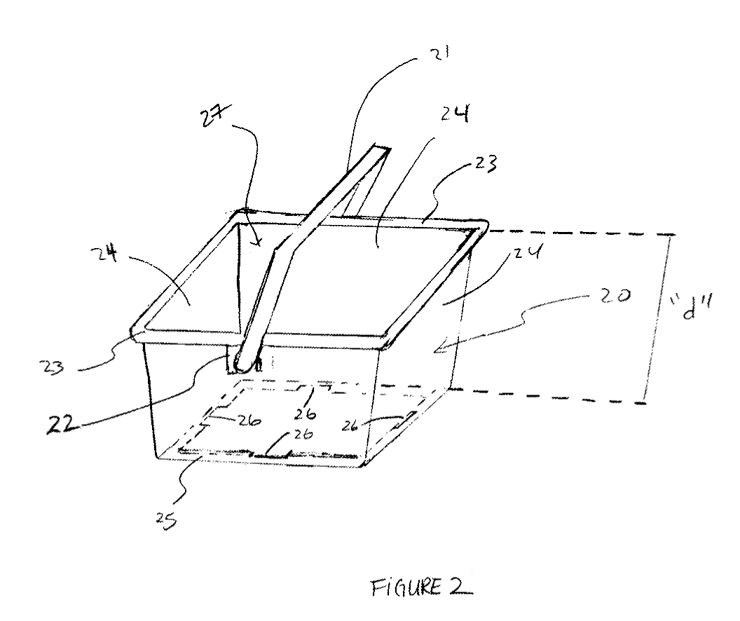

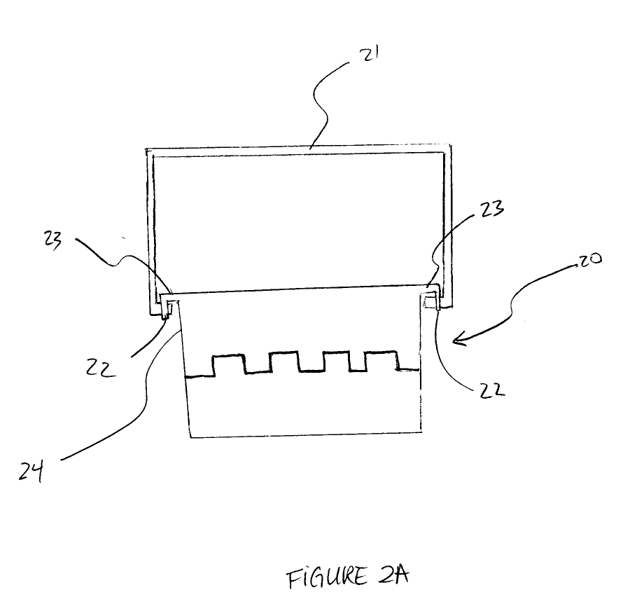

As illustrated in FIG. 1, the container comprises a square cross sectional area. Other cross sectional shapes such as a circle, rectangle, triangle, ellipse, star or any other shape, symmetrical or asymmetrical, may be used. Each section comprises side walls 24 which define the shape and depth “d” of the section (FIG. 2).

Each subsequent section has proportionally decreasing dimension, resulting in the decreasing volume of each subsequent section, thus allowing subsequent sections to be nested within the space defined by a preceding section. Each section may have a decorative pattern along the side walls for imprinting or molding the surface of the sand castle part. Each section may be tapered such that the transition between sections is gradual. Alternatively, each section may have straight edges, such that the transition between sections is stepped.

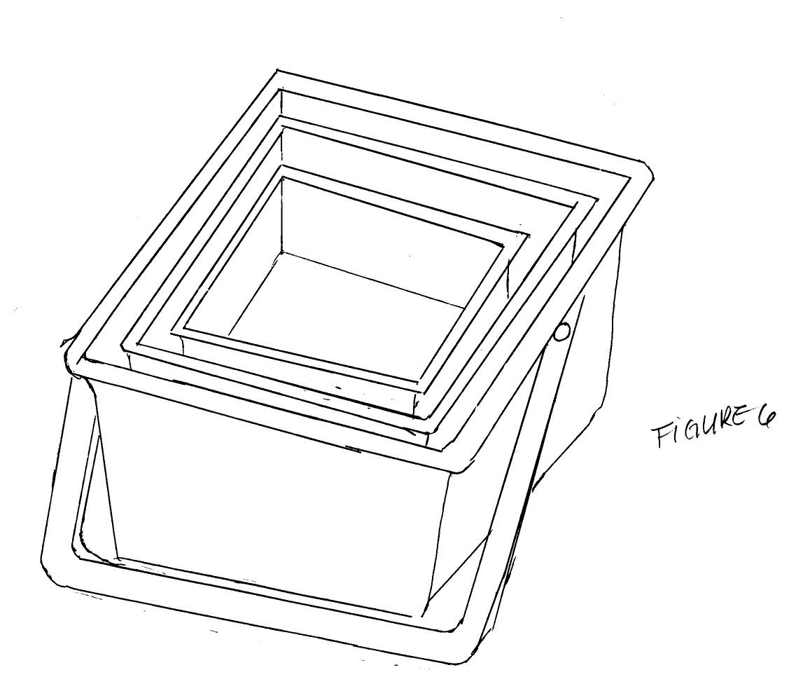

The collapsible container can be any suitable size for the purpose of carrying sand and for molding portions of sand castles. The container should be made of waterproof or water resistant material with sufficient rigidity to allow for molding of sand, and to allow the container to be self supporting when filled with moist sand. The material used should also provide flexibility to allow components to be snap-fitted together, or disengaged easily when detachment is desired. The sections may comprise of decorative patterns 11 along the side walls which can be imprinted on to the molded sand structure to generate ridges or impart other decorative effects onto a sand castle. FIG. 7 illustrates a close up view of one side of the collapsible container in its extended form. The collapsible container comprises an engagement mechanism 60 which allows adjacent sections, such as the top section 20 and the intermediate section 30, to interlock. The engagement mechanism 60 can be a mechanical interlocking mechanism such as a snap-fit joint. Various snap-fit joints such as an annular snap fit joint or ball and socket joints can be used. Other types of mechanical interlocking mechanisms, as well as other suitable engagement mechanisms known to one skilled in the art, can also be used. The engagement mechanism allows the collapsible container to support itself by allowing the sections to snap into position when the container is in an extended position. The engagement mechanism allows the sections to easily disengage to collapse the container.

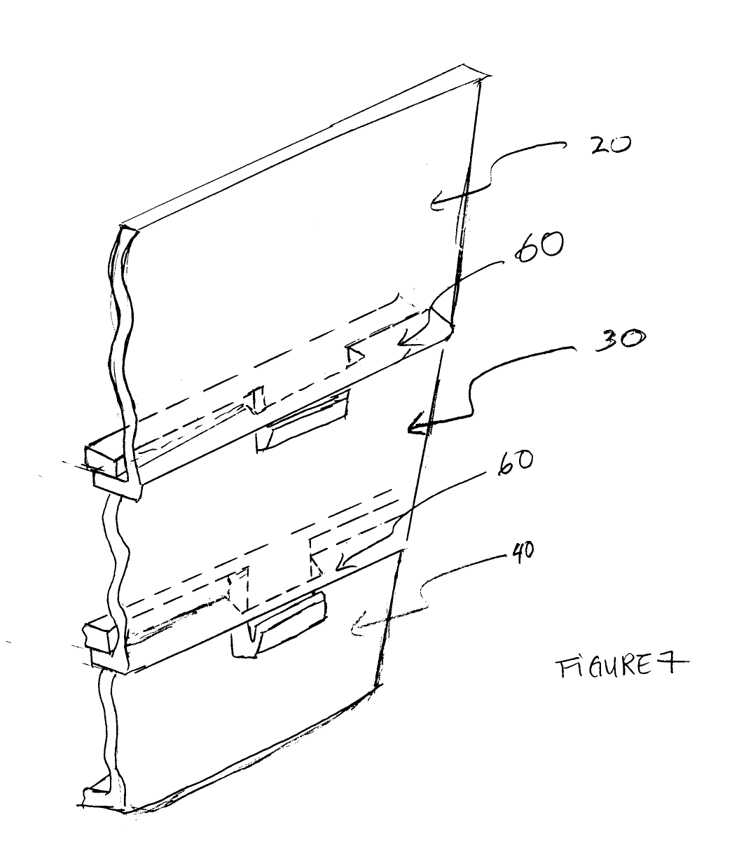

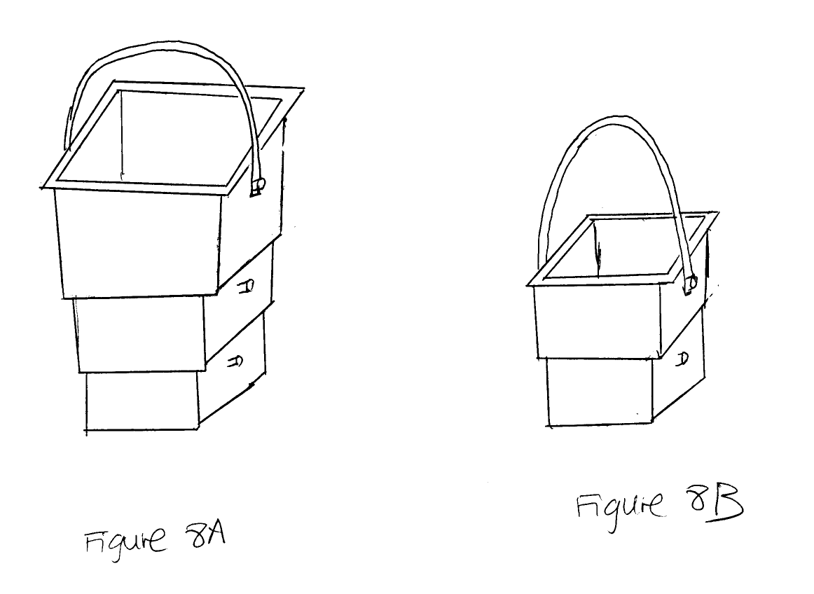

FIGS. 2 and 2A illustrate the top section 20 of the collapsible container. A handle 21 is connected to the top section 20 of the collapsible container by way of a handle interlocking member 22 on either side of the top section 20. The handle interlocking member 22 can be a mechanical interlocking member which allows the handle 21 to snap into the interlocking member 22, or can be a hinge, or any other suitable interlocking mechanism or attachment mechanism known to one skilled in the art. As illustrated in FIGS. 2 and 2A, the interlocking member 22 extends downward from the outward extending upper lip 23 of the top section 20. In an alternative embodiment, the handle may be directly connected to a side wall 24 of the top section 20, such as by attachment to an extended peg. In other embodiments, each section may have a handle attachment member such that when the volume of the container is altered by removing a preceding section, the remaining subsequent sections that form a container of a smaller volume can use the same handle. (FIGS. 8A and 8B). The handle may have an adjustment mechanism (not shown) to adjust the length of the handle to a suitable length for use with smaller container volumes.

The top section 20 further comprises an inward extending lower lip 25 (FIG. 2) which extends perpendicularly from the walls 24 of the top section 20. The inward extending lower lip 25 comprises recessed regions 26 which are part of an engagement mechanism.

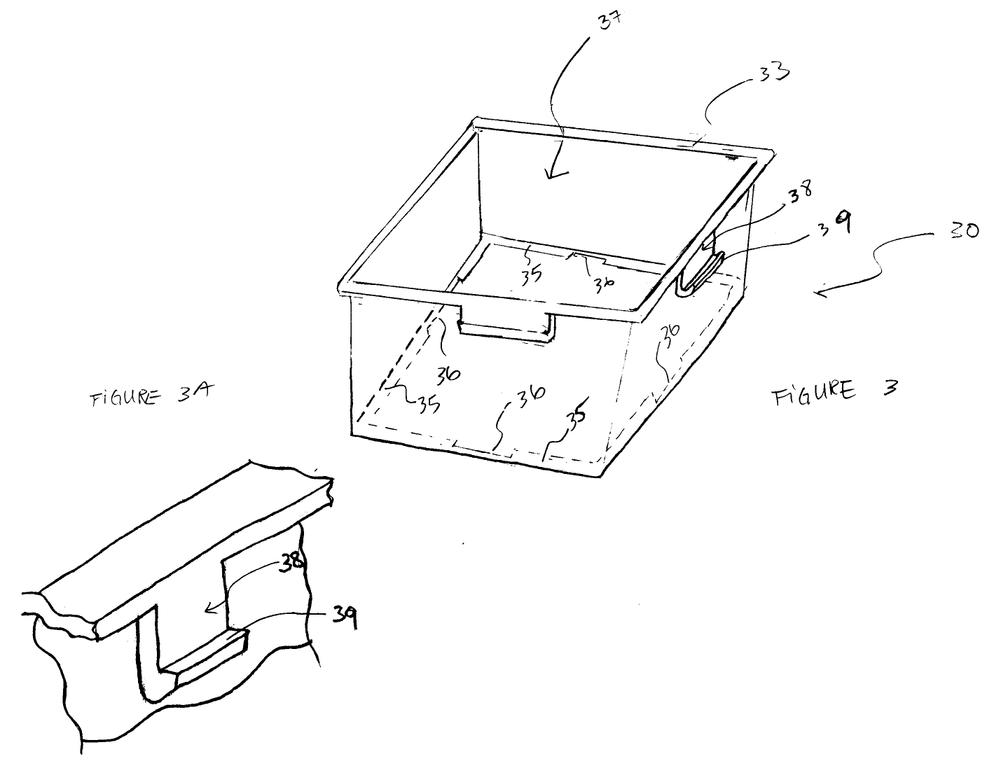

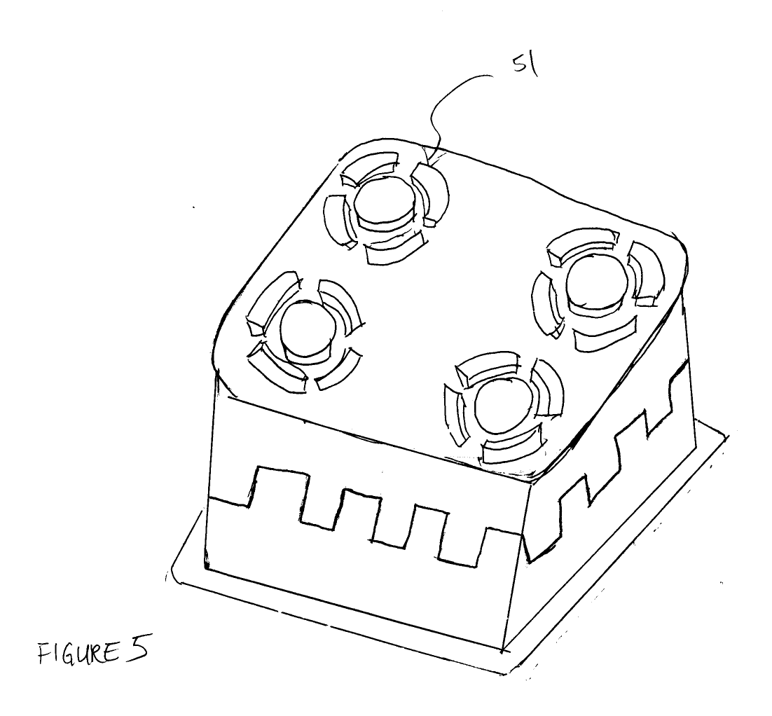

FIG. 3 illustrates the intermediate section 30 of the collapsible container. In a collapsible container with three sections, the top section 20 precedes the intermediate section. In other embodiments with more than three sections, more than one intermediate section can precede another intermediate section. The intermediate section 30 is of the same shape as the preceding section, and defines an interior space 37 with a volume less than the interior space 27 of the preceding section. The decrease in the interior space 37 volume is due to a proportional decrease in dimension of the intermediate section 30, relative to the preceding section. The proportional decrease in dimension of each subsequent section is illustrated in FIG. 6, where each subsequent smaller section is nested within a larger preceding section. The dimensions which decrease can be the length and width, as well as the depth, or alternatively, only the width and length may decrease. This decrease in volume of each subsequent section allows the subsequent sections to be nested within the interior space of the preceding section when the container is in its collapsed position.

To connect the intermediate section 30 with the top section 20 and the bottom section, an interlocking mechanism 60 is used. In one embodiment, the interlocking mechanism is a cantilever snap-fit mechanism as illustrated in FIGS. 7 and 3A. The intermediate section 30 comprises an outward extending upper lip 33 which extends horizontally in a substantially perpendicular direction away from the interior space 37. An arm 38 extends downward from the upper lip 33 on each side of the intermediate section. The arm comprises a hook 39, as illustrated in FIG. 3A, designed to snap-fit into the recessed region 26 of the preceding top section 20.

To extend the collapsible container, each section is pulled out by a preceding section such that the sections are vertically aligned in order of decreasing dimensions. The sections form a self supporting container when the interlocking mechanisms 60 are engaged between sections.

To extend the collapsible container, the user pulls the outermost section upwards such that the subsequent sections are pulled from their nested position into their extended position via a telescoping motion. Subsequent sections are pulled from their nested position due to the engagement of the inward extending lip of a preceding section with the outward extending lip of a subsequent section. Each section is then locked into its extended position so that it is self sustaining.

To lock the collapsible container into an extended position, the upper extending lip of a subsequent section engages with the lower extending lip of the preceding section to keep the subsequent sections from falling through the preceding section. The interlocking mechanism, in this case, the arm 38 and extended ledge 39, locks the subsequent section in place to prevent the container from collapsing onto itself. The arm 38 is slipped through the recessed region 26 of the preceding section, such that the extended ledge 39 is in contact with the remainder of the lower extending lip outside of the recessed region. The sections are made of semi-flexible material to allow the arm 38 and extended ledge 39 to be pulled thorough the recessed region 26 and allow the extended ledge 39 to snap in place below the lower extending lip of the preceding section. Other intermediate sections and the bottom section interlock with their preceding sections in a similar fashion.

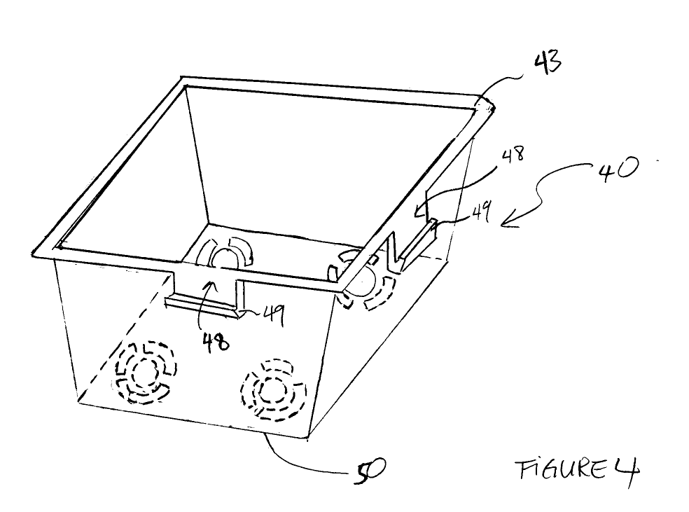

FIG. 4 illustrates the bottom section 40. The bottom section 40 is of the same cross sectional shape as its preceding sections, and comprises a proportionally smaller length and width than preceding sections. The height or depth of the bottom section may be the same, less, or greater than the height or depth of the preceding section, or any other section. Similar to the intermediate sections 30, the bottom section 40 comprises an upper extending lip 43, an interlocking mechanism comprising an arm 48 with a hook 49 on each side of the bottom section 40. The arm 48 and hook 49 of the bottom section 40 work in the same manner as described with respect to the intermediate section for engaging with its preceding section to form a mechanical interlock. The bottom section 40 comprises a bottom surface 50. (FIGS. 4-5). FIG. 5 illustrates the bottom section 40 in an upturned position with the bottom surface 50 facing upwards. The bottom surface 50 comprises decorative molding shapes 51 for generating designs on a sand castle.

Sections can be removed from the container to create containers of varying volumes. The remaining sections can be used to mold sand into sand castle sections. For example, a container with a top section, a bottom section and two intermediate sections can be used in various manners. A user may choose to use the container in its extended position with all four sections, or the user may use each section individually to mold a portion of the sand castle. Alternatively, the user may use the bottom section with one or two intermediate sections, or the two intermediate sections may be used in connection with each other.

Once the desired volume of space is selected, the user fills the container with sand. To mold portions of a sand castle, the user inverts the container and removes the mold. Because the containers are collapsible, and thus easy to store, numerous shapes and sizes of containers can be stored in the space typically taken up by one container, thus providing more variety for the amusement of children.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A collapsible nested container for building sand castles comprising:
a plurality of sections including at least a top section and a bottom section, each section having walls defining a volume of space, at least one section being a preceding section and at least one section being a subsequent section, each subsequent section capable of being nested within the volume of space defined by a preceding section in a collapsed position; and
an engagement mechanism to interlock each preceding section to a subsequent section when the container is in an extended configuration.

2. The container of claim 1 wherein the engagement mechanism is a mechanical interlock.

3. The container of claim 1 wherein the mechanical interlock is a snap-fit mechanism.

4. The container of claim 1 wherein the sections further comprise mold designs on the walls.

5. The container of claim 1 wherein the bottom section has a bottom surface with mold shapes.

6. The container of claim 1 wherein the sections are tapered.

7. The container of claim 1 wherein the sections are proportionally smaller in size.

8. The container of claim 1 wherein subsequent sections of the container, in its collapsed state are nested within preceding sections of the container such that no subsequent section exceeds the dimensions of the preceding section.

9. A container with an adjustable volume for building sand castles comprising:
a plurality of sections including at least a top section and a bottom section, each section having walls defining a volume of space, at least one section being a preceding section and at least one section being a subsequent section, each subsequent section capable of being nested within the volume of space defined by a preceding section in a collapsed position;
an engagement mechanism to interlock each preceding section to a subsequent section when the container is in an extended configuration.

10. The container of claim 9 further comprising intermediate sections between the top section and the bottom section.

11. The container of claim 9 wherein all sections are detachable from other sections.

12. The container of claim 9 wherein two or more sections can be joined together via the engagement mechanism to form a second container with a second volume that is less than the volume of the container when all the sections are joined in an extended configuration.

13. Method of molding sand castles using a container with removable sections comprising:
selecting a volume of space defined by at least one removable section to achieve a desired volume of space to be filled with sand;
filling said volume of space with sand;
removing the at least one removable section from the sand by an upward motion.

14. The method of claim 13, further comprising the step of inverting the volume of space filled with sand defined by the at least one removable section.

15. The method of claim 13, wherein the step of selecting a volume of space further comprises the step of removing or attaching a second removable section to the at least one removable section.

16. The method of claim 13 wherein the step of removing or attaching a second removable section comprises engaging or disengaging a mechanical interlock system.
